(19) United States
(12) Patent Application Publication
(10) Pub. No.: US 2011/0315675 A1
(43) Pub. Date: Dec. 29, 2011

(54) INDUCTION HEATING COOKER

(75) Inventors: Kuniaki Sakakibara, Hyogo (JP); Kenji Watanabe, Nara (JP); Keiko Isoda, Hyogo (JP); Taizo Ogata, Hyogo (JP)

(73) Assignee: PANASONIC CORPORATION, Kadoma-shi, Osaka (JP)

(21) Appl. No.: 13/256,126

(22) PCT Filed: Mar. 8, 2010
(86) PCT No.: PCT/JP2010/001585

§ 371 Date: Sep. 12, 2011

(30) Foreign Application Priority Data
Mar. 19, 2009 (JP) 2009-067423

(51) Int. Cl. H05B 6/12

(52) U.S. Cl. 219/622

(57) ABSTRACT

There are provided amplifying part (5) for amplifying an output signal of infrared detecting part (4), gain switching part (6) for switching a gain of amplifying part (5) to one of a plurality of gains according to magnitude of the output signal of amplifying part (5), and measuring part (12) for calculating a temperature based on an increase in the output signal of amplifying part (5) relative to an initial reference value, and after writing command input part (11) input a writing command, the output signal of amplifying part (5) is written as the initial reference value for each of the plurality of gains in storage medium (13). Since measuring part (12) uses the initial reference value corresponding to the gain as the initial reference value, temperature of object to be heated (1) can be accurately measured over a wide range.

### TECHNICAL FIELD

The present invention relates to an induction heating cooker for detecting temperature of an object to be heated using an infrared detecting part.

### BACKGROUND ART

Induction heating cooker detects temperature of an object to be heated such as a pan placed on a top plate. Conventional induction heating cookers detect temperature of the object to be heated through the top plate by use of a thermistor. Moreover, conventional induction heating cookers detect an infrared ray emitted from a side surface of the object to be heated by use of an infrared sensor provided at a rear part of an upper surface of the top plate, thereby detecting the temperature of the object to be heated. Further, the conventional induction heating cookers detect the temperature of the object to be heated by detecting the infrared ray emitted from the object to be heated through the top plate by use of an infrared sensor provided on a lower surface of the top plate. Furthermore, an induction heating cooker disclosed in PTL 1 detects a wide temperature range by switching an amplification factor (gain) of an output signal from the infrared sensor for detecting the temperature of the object to be heated.

The detection of temperature by use of the infrared sensor is performed by calculation based on an amount of change from an initial reference value of the infrared sensor. The initial reference value of the infrared sensor is an output signal from the infrared sensor in the case where the infrared sensor receives an infrared ray emitted from an object having a temperature not higher than the lowest temperature that can be detected by the infrared sensor. This initial reference value is ideally constant irrespective of a change in the gain of an amplifying part.

However, since the above-mentioned conventional induction heating cookers have variations in offset voltage and current of an amplifier constituting the amplifying part and a gain switching part and the infrared sensor or resistance value of a resistor and the like, when the gain of the amplifying part is changed, variation in the initial reference value occurs. That is, when the initial reference value is set to one fixed value irrespective of the gain, disadvantageously, the temperature is not correctly calculated.
PTL 1: Unexamined Japanese Patent Publication No. 2005-347000

### SUMMARY OF THE INVENTION

To solve the above-mentioned problem, the present invention provides a easy-to-used and highly safe induction heating cooker that can accurately detect temperature of a bottom surface of an object to be heated even when a gain of an amplifying part is changed, and control the temperature of the bottom surface of the object to be heated based on the accurate temperature.

An induction heating cooker of the present invention includes a heating coil for heating an object to be heated, a top plate provided above the heating coil and for carrying the object to be heated placed thereon, an infrared detecting part provided under the top plate and for detecting an infrared ray emitted from a bottom surface of the object being heated. The induction heating cooker of the present invention further includes an amplifying part having a plurality of staged gains and for amplifying an output signal from the infrared detecting part, a gain switching part for switching the gain of the amplifying part to one of the plurality of gains according to an output value from the amplifying part, a measuring part for calculating a temperature based on an increase in the output value from the amplifying part relative to an initial reference value, a heating control part for controlling a high-frequency current supplied to the heating coil based on the temperature calculated by the measuring part, a storage medium for storing therein the output value from the amplifying part, and a writing command input part for inputting a writing command to store the output value from the amplifying part in the storage medium. Further, in the induction heating cooker of the present invention, the storage medium stores the output value from the amplifying part as the initial reference value for each of the plurality of gains after the writing command input part inputs the writing command. Furthermore, in the induction heating cooker of the present invention, the measuring part calculates the temperature by using the initial reference value stored in the storage medium when performing normal heating of the object to be heated.

With such a configuration, the temperature based on the output signal of the amplifying part is calculated by using the initial reference value corresponding to the gain. Thus, infrared detecting part can detect the accurate temperature of the object to be heated to perform temperature control. Therefore, it is possible to provide a highly safe induction heating cooker having a function of accurately adjusting the temperature of the object to be heated.

### BRIEF DESCRIPTION OF THE DRAWINGS

FIG. 1 is a configuration view of an induction heating cooker according to a first exemplary embodiment of the present invention.

FIG. 2 is a circuit diagram of an amplifying part of the induction heating cooker according to the first exemplary embodiment.

### DETAILED DESCRIPTION OF THE PREFERRED EMBODIMENTS

### First Exemplary Embodiment

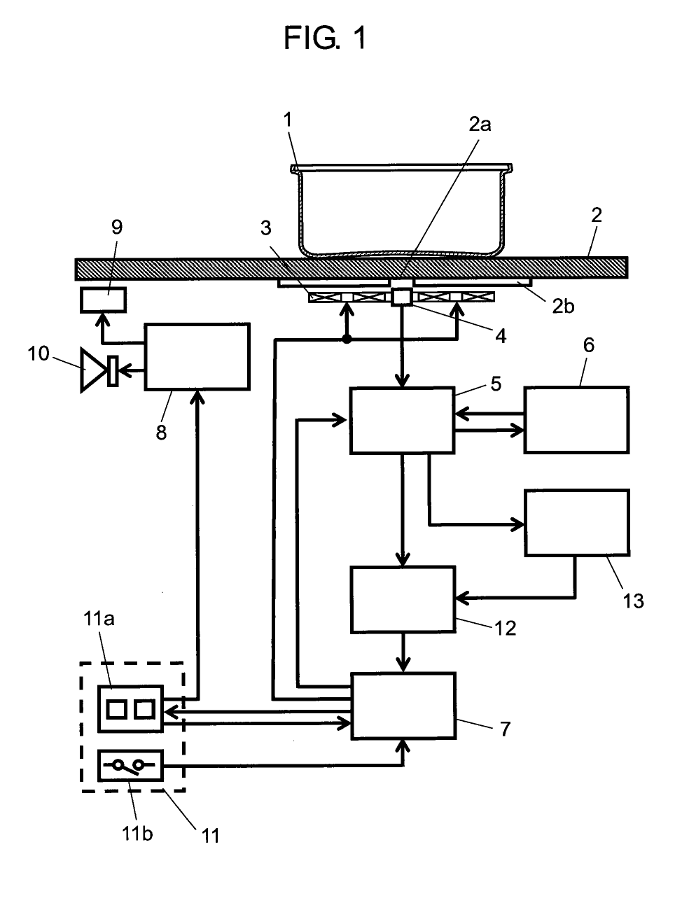

FIG. 1 is a configuration view of an induction heating cooker according to a first exemplary embodiment of the present invention. As shown in FIG. 1, the induction heating cooker according to this embodiment includes top plate 2 for placing cooking vessel 1 as an object to be heated thereon, heating coil 3 for generating an induction field for heating cooking vessel 1, and infrared detecting part 4 provided under top plate 2. Infrared detecting part 4 detects an infrared ray emitted from a bottom surface of cooking vessel 1 and passed through top plate 2 and controls a heating output corresponding to the amount of the infrared ray.

Further, the induction heating cooker according to this embodiment has a plurality of gains and includes amplifying part 5 for amplifying an output signal of infrared detecting part 4 and gain switching part 6 for switching the gains of amplifying part 5 to a plurality of staged gains according to an output value from amplifying part 5. The induction heating cooker according to this embodiment further includes measuring part 12 for measuring an increase in the output value from amplifying part 5 relative to an initial reference value and calculating temperature of the bottom surface of cooking vessel 1 based on the increase. The induction heating cooker according to this embodiment further includes heating control part 7 for variably controlling magnitude of a high-frequency current applied to heating coil 3 based on temperature information from measuring part 12.

The induction heating cooker according to this embodiment further includes storage medium 13 for storing the output value from amplifying part 5 therein and writing command input part 11 for inputting a writing command to store the output from amplifying part 5 in storage medium 13. The writing command input part 11 serves both as predetermined keys of operating part 11a for operating a device and power switch 11b in general heating cooking. Operating part 11a is configured of a plurality of keys including a tact switch, an electrostatic touch key, and the like. The operating part 11a communicates with heating control part 7 in a bi-directional way and transmits/receives a control command. In the general heating cooking, power switch 11b changes a state where a heating operation of operating part 11a is disabled to a state where the heating operation of operating part 11a is enabled. Further, in the general heating cooking, power switch 11b changes the state where the heating operation of operating part 11a is enabled to the state where a heating operation of operating part 11a is disabled.

Heating control part 7 variably controls magnitude of the high-frequency current by performing on/off drive control of a switching element of an inverter not shown. The induction heating cooker according to this embodiment further includes display part 9 formed of a light-emitting diode (LED) or a liquid crystal display (LCD), sound output part 10 that is formed of a buzzer or a speaker and outputs an annunciation sound or human's voice (hereinafter, referred to as merely the sound), and sound display control part 8 for controlling display and sound output to display part 9 and sound output part 10.

Operations of the induction heating cooker thus configured will be described below. First, the output signal from infrared detecting part 4 is amplified by amplifying part 5. The amplified output signal is measured by measuring part 12. Measuring part 12 calculates the temperature of the bottom surface of cooking vessel 1 based on the measured signal.

Even after amplification by amplifying part 5, the output signal from infrared detecting part 4 may be still small and fall below a range that can be measured by measuring part 12. In this case, it is need to amplify the output signal from infrared detecting part 4 by using a larger amplification factor. Thus, gain switching part 6 switches the gain of amplifying part 5 having three stages of gains in advance. In this embodiment, the three stages of gains are referred to as a low gain, an intermediate gain, and a high gain in ascending order of the amplification factor.

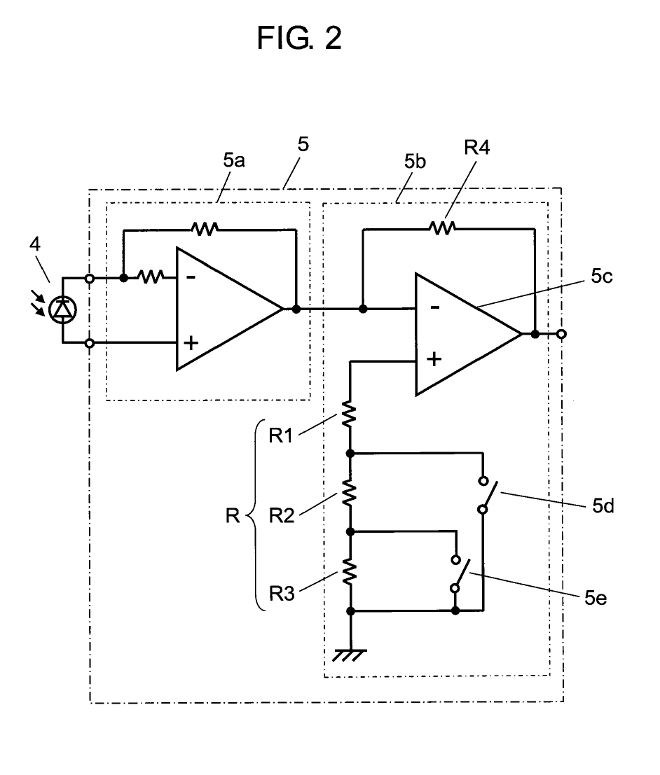

FIG. 2 is a circuit diagram of amplifying part 5 of the induction heating cooker in the first exemplary embodiment of the present invention. In FIG. 2, amplifying part 5 includes current voltage converter 5a and voltage amplifier 5b for further amplifying an output of current voltage converter 5a. Voltage amplifier 5b has operational amplifier 5c, resistor R formed of a series circuit of resistors R1, R2 and R3, resistor R4, switch 5d connected in parallel to a series circuit of resistors R2 and R3, and switch 5e connected in parallel to resistor R3. The gain of amplifying part 5 is determined depending on a ratio (R4/R) of resistor R to resistor R4. Switch 5d and switch 5e are turned on/off according to a signal from gain switching part 6. When gain switching part 6 turns off both of switch 5d and switch 5e, the low gain is determined. When gain switching part 6 turns off switch 5d and turns on switch 5e, the intermediate gain is determined. When gain switching part 6 turns on switch 5d, the high gain is determined. Gain switching part 6 receives an input of the output signal from amplifying part 5 and changes combination of on/off of switches 5d, 5e according to magnitude of the output signal, thereby switching the gain of amplifying part 5. In other words, when the output signal from amplifying part 5 becomes larger than an upper limit, the gain of the amplifying part 5 is switched to be smaller.

The three stages of gains are used as follows. At the start of heating of cooking vessel 1 of low temperature (for example, room temperature), the temperature of the bottom surface of cooking vessel 1 is still low, and therefore, the amount of emitted infrared ray is small. In this case, since the output signal from infrared detecting part 4 is small, the output signal needs to be amplified to be large and be transmitted to measuring part 12. That is, when the output value from amplifying part 5 is smaller than a first predetermined value (for example, a voltage value that is converted into the temperature of the bottom surface of cooking vessel 1 and corresponds to 230° C.), gain switching part 6 sets the gain of amplifying part 5 to the high gain. Conversely, when heating time of cooking vessel 1 becomes long, the temperature of the bottom surface of cooking vessel 1 becomes higher and the output signal from amplifying part 5 becomes larger than a second predetermined value (for example, a voltage value that is converted into the temperature of the bottom surface of cooking vessel 1 and corresponds to 270° C.), which is larger than the first predetermined value. In this case, amplification of the output signal not necessarily be small. That is, gain switching part 6 switches the gain of amplifying part 5 to the low gain. When the output signal from amplifying part 5 is not less than the first predetermined value and not more than second predetermined value, gain switching part 6 switches the gain of amplifying part 5 to the intermediate gain. In this manner, gain switching part 6 switches the gain so that the signal transmitted from amplifying part 5 to measuring part 12 falls within a range that can be measured by measuring part 12. Thereby, the measurable temperature range is extended.

Cooking vessel 1 is placed on top plate 2. In order to detect the temperature of the bottom surface of cooking vessel 1 by use of infrared detecting part 4, cooking vessel 1 is placed immediately above infrared ray detecting window 2a that is formed on top plate 2 and serves as a transmittance region of the infrared ray. Shading film 2b is formed on top plate 2 surrounding infrared ray detecting window 2a by printing or the like. Thereby, a path where the infrared ray enters into the infrared sensor is limited to a path where the infrared ray passes through infrared ray detecting window 2a. When cooking vessel 1 is placed immediately above infrared ray detecting window 2a, external disturbance light passing through infrared ray detecting window 2a is eliminated. Thereby, the infrared ray passing through infrared ray detecting window 2a is mainly infrared ray emitted from the bottom surface of cooking vessel 1 and is received by infrared detecting part 4.

Here, detection of the temperature of the bottom surface of cooking vessel 1 by use of infrared detecting part 4 will be described. When receiving the infrared ray, infrared detecting part 4 issues an output corresponding to the amount of infrared ray (for example, voltage output). Measuring part 12 performs the detection of temperature of the bottom surface of cooking vessel 1 with use of infrared detecting part 4 by calculation based on an increase from a reference output signal of the amplifying part 5. The reference output signal is an output signal (for example, output voltage) in the case where an infrared ray emitted from an object having a temperature not higher than the lowest temperature that can be detected by infrared detecting part 4 is received. In this embodiment, this reference output signal is referred to as an initial reference value.

Next, acquisition of the initial reference value will be described. The initial reference value is acquired by storing the initial reference value in storage medium 13. The acquiring operation of the initial reference value is performed by placing cooking vessel 1 of room temperature (for example, 25° C.) on top plate 2 so as to cover infrared ray detecting window 2a with the bottom surface of cooking vessel 1. In storage of the initial reference value, the temperature of the bottom surface of cooking vessel 1 must be lower than the lowest temperature (for example, 140° C.) that can be detected by infrared detecting part 4.

By operation of writing command input part 11, a mode is shifted to a control mode of acquiring the initial reference value (hereinafter, referred to as an initial reference value acquiring mode). The initial reference value acquiring mode is different from control to perform the heating operation by the user with the operating part 11a in general cooking. In this embodiment, writing command input part 11 serves both as predetermined keys of operating part 11a and power switch 11b. The user turns on power switch 11b while performing a predetermined key operation in operating part 11a, thereby shifting the mode to the initial reference value acquiring mode. By outputting an initial reference value acquiring command from heating control part 7 to amplifying part 5 at a predetermined timing since shift to initial reference value acquiring mode, acquisition of the initial reference value is started. As for the timing of acquiring the initial reference value, the initial reference value may be acquired immediately after shift to the initial reference value acquiring mode. Other processing such as a performance inspection may be performed before or after acquisition of the initial reference value. When acquisition of the initial reference value is started, amplifying part 5 outputs a gain switching request to gain switching part 6. When receiving the gain switching request, gain switching part 6 first switches the gain to one of the three stages of gains to set the amplification gain of amplifying part 5. In this embodiment, gain switching part 6 switches the gain to the low gain. As described above, the gain of amplifying part 5 is first set to the low gain. Here, the predetermined key operation is an operation that cannot be easily performed by the user. The predetermined key operation is, for example, an operation of pressing the plurality of keys of the operating part 11a at the same time. Sound display control part 8 informs the user that the initial reference value acquiring mode is working. Thereby, the user is prevented from carelessly operating the induction heating cooker before completion of acquisition of the initial reference value, thereby preventing interference of acquisition of the initial reference value.

Informing the user is performed through, for example, a sound output from sound output part 10 or display on display part 9. Specifically, in the case of using sound output part 10, the sound may be outputted at the shift to the initial reference value acquiring mode and at the completion of the initial reference value acquiring mode. Through informing of completion, the user can reliably recognize that acquisition of the initial reference value is completed. For this reason, the initial reference value can be acquired without any failure. In the case of using the display part 9, display showing that the initial reference value acquiring mode is working may continue during the initial reference value acquiring mode.

The output value from amplifying part 5, which is obtained by amplifying the output signal from infrared detecting part 4 at the predetermined timing after shift to the initial reference value acquiring mode, is written as the initial reference value in storage medium 13 (for example, a data flash region of a microcomputer not shown). In other words, the initial reference value at the low gain is written in storage medium 13. Here, if the output value from amplifying part 5 is out of a predetermined range, this output value from amplifying part 5 is handled as an error and is not written in storage medium 13. Here, the predetermined range is a range from a lower limit to an upper limit, in which measuring part 12 can measure the output signal from infrared detection part 4.

Accordingly, when the output signal from amplifying part 5 is less than the lower limit or is larger than the upper limit, the output value is out of the predetermined range. In such a case where the acquired value is handled as the error and is not written to storage medium 13, a general value prepared in advance is written as the initial reference value in storage medium 13. Thereby, it is prevented that the induction heating cooker operates based on an abnormal value without the predetermined range and is put into an unsafe state. Conversely, it is prevented that temperature higher than the temperature of the bottom surface of cooking vessel 1 is detected and the heating output is unnecessarily limited.

Next, as the next stage, gain switching part 6 switches the gain of amplifying part 5 to, for example, the intermediate gain. Thereby, the amplification gain of amplifying part 5 is set to the intermediate gain. As in the above-mentioned case of the low gain, the initial reference value at the intermediate gain is written to storage medium 13. Further, similarly, the initial reference value at the high gain is written to the storage medium 13. In this manner, the initial reference value at each of the three stages of gains, that is, the low gain, the intermediate gain, and the high gain, is written to storage medium 13 and stored therein.

When the induction heating cooker according to this embodiment performs heating control by the key operation of operating part 11a in general heating cooking, measuring part 12 calculates the temperature of the bottom surface of cooking vessel 1 based on the initial reference value at each gain, which is previously stored in the above-mentioned manner. For example, when amplifying part 5 amplifies the output signal from infrared detecting part 4 at the low gain, the temperature of the bottom surface of cooking vessel 1 is calculated using a difference between the current output signal from amplifying part 5 and the initial reference value at the low gain. Using the temperature of the bottom surface thus calculated, heating control part 7 controls a heating with heating coil 3. Similarly, in the case of heating at the intermediate gain, a difference between the current output signal from amplifying part 5 and the initial reference value at the intermediate gain is used, and in the case of heating at the high gain, a difference between the current output signal from amplifying part 5 and the initial reference value at the high gain is used.

Thereby, the temperature at each gain is correctly calculated. Accordingly, since the temperature of the bottom surface of cooking vessel 1 is accurately detected and temperature control is performed based on the accurate temperature, it is possible to provide the highly safe induction heating cooker having a highly accurate automatic temperature adjusting function.

When acquisition of the initial reference value fails or writing of the initial reference value to storage medium 13 fails, sound display control part 8 may inform the user of the failure. Thereby, it is possible to request the user to perform the acquiring operation of the initial reference value again. Further, it is also possible to request the user to check presence or absence of failure of the device. In addition, it is possible to request the user to confirm the installation state of the cooking vessel.

Informing the user is performed, for example, through the sound output from sound output part 10 or error display on display part 9. Therefore, it is possible to easily determine whether or not the initial reference value is normally acquired. Thereby, if the initial reference value is not normally acquired, the induction heating cooker can be treated as a defective unit.

Although the predetermined keys of operating part 11a and power switch 11b are used as writing command input part 11 in this embodiment, the present invention is not limited to this configuration. For example, a dedicated switch may be provided as writing command input part 11. This dedicated switch may be provided at a place that cannot be easily touched by the user, for example, a place that cannot be operated unless a cover is detached by use of a tool. A receiving part that can receive an infrared signal or a radio signal may be further provided and an external transmitting part may transmit the infrared signal or the radio signal as the writing command. As described above, writing command input part 11 is not limited to the embodiments and only needs to be able to input the writing command as a command to shift the mode to the initial reference value acquiring mode.

### INDUSTRIAL APPLICABILITY

Since the induction heating cooker of the present invention can accurately detect the temperature of the cooking vessel, the induction heating cooker can be used as induction heating cookers used in household and industrial applications.

### REFERENCE MARKS IN THE DRAWINGS

1 cooking vessel (object to be heated)

2 top plate

2a infrared ray detecting window

2b shading film

3 heating coil

4 infrared detecting part

5 amplifying part

5a current voltage converter

5b voltage amplifier

5c operational amplifier

5d, 5e switch

6 gain switching part

7 heating control part

8 sound display control part

9 display part

10 sound output part

11 writing command input part

11a operating part

11b power switch

12 measuring part

13 storage medium

1. An induction heating cooker comprising:
a heating coil for heating an object to be heated;
a top plate provided above the heating coil and for carrying the object to be heated placed thereon;
an infrared detecting part provided under the top plate and for detecting an infrared ray emitted from a bottom surface of the object being heated;
an amplifying part having a plurality of staged gains and for amplifying an output signal from the infrared detecting part;
a gain switching part for switching the gain of the amplifying part to one of the plurality of gains according to an output value from the amplifying part;
a measuring part for calculating a temperature based on an increase in the output value from the amplifying part relative to an initial reference value;
a heating control part for controlling a high-frequency current supplied to the heating coil based on the temperature calculated by the measuring part;
a storage medium for storing therein the output value from the amplifying part; and
a writing command input part for inputting a writing command to store the output from the amplifying part in the storage medium, wherein
the storage medium stores the output value from the amplifying part as the initial reference value for each of the plurality of gains after the writing command input part inputs the writing command, and the measuring part calculates the temperature by using the initial reference value stored in the storage medium when performing normal heating of the object to be heated.

2. The induction heating cooker according to claim 1, wherein the storage medium stores a predetermined value as the initial reference value in place of the output value from the amplifying part if the output value is out of a predetermined range when writing the output value from the amplifying part.

3. The induction heating cooker according to claim 1, wherein the writing command input part further includes an operating part having a plurality of keys for operating the cooker when performing normal heating of the object to be heated, and inputs the writing command when a predetermined key operation is made on the operating part.

4. The induction heating cooker according to claim 1, further comprising a display part, wherein the display part displays that the initial reference value is being acquired during acquisition of the initial reference value.

5. The induction heating cooker according to claim 1, further comprising a display part, wherein the display part displays an indication of error if the output value from the amplifying part is out of a predetermined range when writing the output value from the amplifying part in the storage medium.

6. The induction heating cooker according to claim 1, further comprising a sound output part for outputting a sound, wherein the sound output part outputs a sound after the writing command input part inputs the writing command or acquires the initial reference value.

7. The induction heating cooker according to claim 6, wherein the sound output part outputs a sound if a failure occurs in writing the initial reference value in the storage medium.
